(19) United States
(12) Patent Application Publication
(10) Pub. No.: US 2005/0047350 A1
(43) Pub. Date: Mar. 3, 2005

(54) Apparatus and methods for discovery of network elements in a network

(76) Inventors: Milan Kantor, Ottawa (CA); Richard Warnock, Carp (CA); Robert Williams, Ottawa (CA); Dan Fossum, Ottawa (CA)

Correspondence Address: SMART & BIGGAR/FETHERSTONHAUGH & CO.;P.O. BOX 2999, STATION D, 900-55 METCALFE STREET, OTTAWA, ON, K1P5Y6, CA

(21) Appl. No.: 10/933,305

(22) Filed: Sep. 3, 2004

Related U.S. Application Data
(60) Provisional application No. 60/499,390, filed on Sep. 3, 2003.

(51) Int. Cl. H04L 12/28

(52) U.S. Cl. 370/254; 370/395.2

(57) ABSTRACT

A method of discovering information about a network in which a plurality of network elements on the network are each configured to use a different communication method to permit access to information stored in said network element. The method comprises the steps of attempting to communicate with each network element using one or more different communication methods, monitoring the responses, if any, from said network elements, and determining the communication method used by each network element based on the responses.

### REFERENCE TO RELATED APPLICATIONS

This application claims priority from U.S. Proviaional Application No. 60/499,390 filed on 3^{rd} Sep. 2003.

### FIELD OF THE INVENTION

The present invention relates to discovery of network elements and their topology in a network, and in particular, but not limited to discovery of optical network elements in an OSI (Open Systems Interconnect) based network.

### BACKGROUND

Network operators are continually seeking ways to reduce costs while increasing the speed of delivery of end-to-end services. In many cases this must be done in networks consisting of multi-vendor equipment, especially in cases where there has been consolidation of two or more existing networks into one.

Crucial to achieving these objectives is visibility and understanding of the details of the layer 1 (physical) network composition, i.e. the physical devices (NEs) and the connections between them. The network operators require an up-to-date and accurate picture of their entire network in order to efficiently manage and use it. This picture is the foundation for efficient inventory, fault and facility management as well as end-to-end network provisioning.

Past reliance on a view of the network created from manually entered data in disparate systems has proven inefficient and costly due to: difficulty in assessing when new investment is required; poor handling of some alarms and faults; stranded bandwidth from over-provisioning or misunderstood provisioning; provisioning inefficiencies and long service turn-up times; and ongoing operational inefficiencies for things like NE database backup and software upgrade.

To address these issues the solution for the network operator is to work with a discovered view of the network reflecting its current, real structure instead of a static view based on manually entered data. To be useful, the picture provided by network discovery must have the following characteristics: it must be accurate, i.e. it reflects an initial auto-discovery of all NEs followed by smart polling to include any ongoing changes; it must be complete, i.e. discovery must communicate with all NEs regardless of vendor type and communication protocol; and it must be data-rich, i.e. include resources (cards, ports and facilities), topology (neighbours and connections) and status (revision levels and operational status).

A certain amount of network discovery can be done by directly querying an NE over an industry-standard interface such as TL1. However, the amount and utility of the information retrieved in such a fashion is limited by the capabilities of the particular NE. In particular, SONET equipment vendors in the past have not generally included a full set of native discovery and diagnostic tools in their network elements. As such, more elaborate and generic discovery techniques are required.

### SUMMARY OF ASPECTS OF THE INVENTION

According to a first aspect of the present invention, there is provided a method of establishing communication with a network element comprising: (1) logging into said network element; (2) transmitting to said network element one or more prompts each of which causes said network element to return a response; (3) receiving and analysing each response; (4) determining a method of connection to said network element based on said one or more response.

According to another aspect of the present invention, there is provided an apparatus for discovering information on a communications network, comprising means for transmitting a signal to a network element to retrieve therefrom information about said network element, means for identifying the network element from the retrieved information, means for selecting a method of collecting with said network element based on the identification thereof, and means for establishing a connection with said network element using the selected method.

According to another aspect of the present invention, there is provided a method of discovering network elements on a network comprising the steps of retrieving information from a network element about other network elements on the network and using the retrieved information to communicate with the discovered network elements to retrieve further information about said network elements.

According to another aspect of the present invention, there is provided a method of discovering network elements on a network comprising the steps of retrieving from a network element information about other network elements on the network, and communicating with a network element so identified and requesting therefrom information about other networked elements on the network.

According to another aspect of the present invention, there is provided a method of determining the topology of a network comprising establishing communication with one or more network elements; determining from said one or more network elements, the identity of one or more other network elements on the network; and determining one or more positional relationships between a plurality of said network elements.

According to another aspect of the present invention, there is provided a computer readable storage medium comprising code which, when in use, causes a network probe to perform a method as defined in any method as claimed or described or part thereof.

According to another aspect of the present invention, there is provided the use of an OSI application layer and an OSI network layer to determine information about network elements on a network including: determining multi-vendor NE presence and topology; reconciling network topology information from multiple sources; adapting NE command output to use as input for further OSI network layer discovery.

### BRIEF DESCRIPTION OF THE DRAWINGS

Examples of embodiments of the present invention will now be described with reference to the drawings in which:—FIG. 1 shows a block diagram of a network topology discovery system and/or flow diagram according to an embodiment of the present invention;

FIGS. 2A, 2B and 2C show diagrams of data structures used during discovery of one or more network elements;

FIG. 3 shows an example of a network to which an embodiment of a network probe is connected;

FIG. 4 shows another example of a communication network to which an embodiment of a network probe is connected;

FIG. 5 shows an example of a port connection signature;

FIG. 6 shows a schematic diagram of a network whose topology is to be discovered;

FIG. 7 shows an algorithm for determining all vertical paths between nodes;

FIG. 8 shows another schematic diagram of the network shown in FIG. 6;

FIG. 9 shows an example of communications between network elements;

FIG. 10 shows a schematic diagram of an example of a method for acquiring information about a network using an error report packet;

FIG. 11 shows a schematic of an example of a method of acquiring information about a network using an echo reply; and

FIG. 12 shows an algorithm for determining horizontal paths between nodes.

### DESCRIPTION OF EMBODIMENTS OF THE INVENTION

The discovery apparatus and method according to embodiments of the present invention obtain and preferably maintain an accurate description of a physical network. The apparatus and method typically take as an input a small amount of “seed” data and some information about equipment login/security, and use this information possibly with data obtained directly from the network to produce two distinct outputs:
(1) a comprehensive list of network elements present in the network, and
(2) a representation or description of the topological relationships between the various network elements.

Network element and topology information is produced using data which may be obtained by at least one of two distinct methods:
(1) querying the discovered network elements at the application layer (OSI layer 7) and/or
(2) actively participating in the underlying network layer and using OSI network layer (layer 3) tools.

If information from both sources is available, network element and topology information may be produced by reconciling data obtained by both methods.

Embodiments of the present invention include application layer tools which rely on the ability of a network element (NE) to explicitly provide information about itself. The application layer tools may also obtain information from an NE about its neighbours, its connectivity to its neighbours and the surrounding network, if this information is available. For example, if the “seed” data includes authentication information which enables one or more “seed” network elements to be logged into, the seed NEs are explicitly queried for neighbour and other network composition information. Each additional potential network element found by this step may be treated as another seed NE. Thus, by applying an iterative process, a much larger collection of NEs can be discovered from a single seed.

Generally a login or security authentication procedure must succeed before the application layer query method can succeed in producing information. Furthermore, application layer data retrieval relies, at minimum, on knowledge of the specific management protocols and command syntax supported by that particular NE. This is made more complex by the fact that even for the same equipment vendor and NE type, the protocols and syntax in use may vary from one software release to another. Embodiments of the discovery method apply a set of heuristics to the seed and retrieved data to aid in this determination.

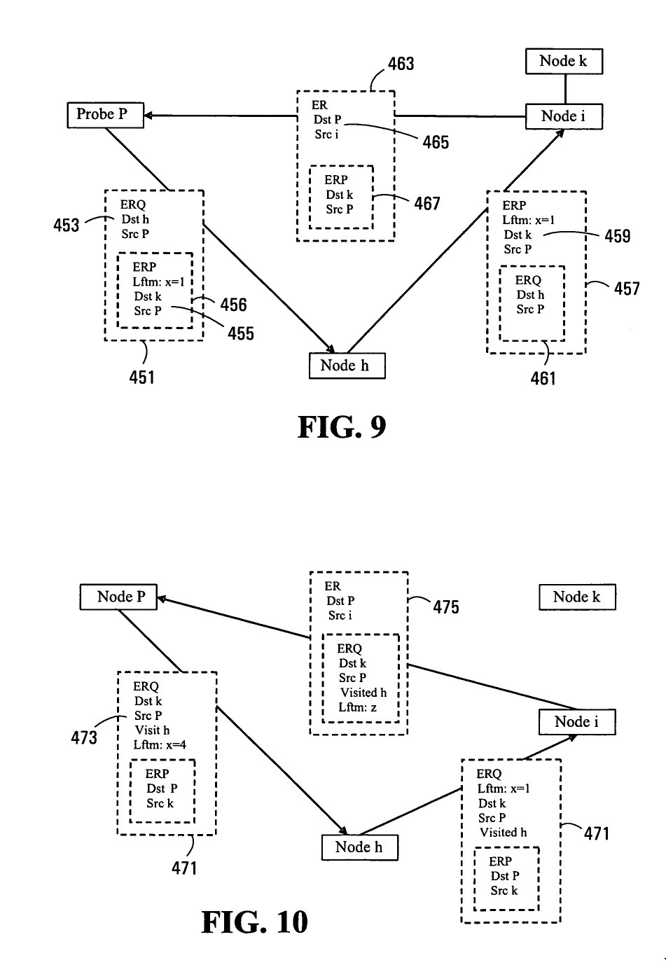

Embodiments of an NE discovery system will now be described with reference to FIGS. 1 to 12.

Component Overview

Referring to FIG. 1, an embodiment of a network discovery system, generally shown at 1, comprises a discovery service manager 3, a discovery agent 7 and one or more discovery workers 9, 11, 13, 15, 17.

Each network element on an OSI network has a globally unique network address, i.e. NSAP (Network Service Access Point) address which is used by the network layer to route data packets. OSI network elements may, in addition, have an IP (internet protocol) address if they support IP. OSI network elements may also include a unique application layer address by which the NE can be identified for application layer (e.g. management) messaging. For example, TL1 (transaction language 1)—managed NEs are uniquely identified in a network by a TL1 target identifier (TID). TIDs serve as the common name of a TL1 network element and are used at the application layer to identify the NE for the purposes of TL1 messaging. In an OSI network, network layer routing acts on CLNP (Connectionless Network Protocol) addresses in order to forward messages to their destinations. Accordingly, TIDs must be mapped to the corresponding CLNP addresses (NSAPs) in order to communicate to a remote NE across an OSI network.

“Seed NE data” may include one or more NE IP addresses and/or OSI network layer addresses (e.g. NSAP's) and optionally one or more application layer addresses (e.g. TIDs) or other identifying information.

The discovery service manager 3 manages a list of requests for NE discovery from one or more sources. In this embodiment, the list of requests is generated from seed data provided at a user input 2, from periodic background discoveries of the network based on existing NEs contained in a database 5 or from NEs discovered by the discovery agent 7. Individual NE discovery requests may be managed by the discovery service manager through a state machine that guides different phases of discovery, which may include but are not limited to fingerprinting, neighbour discovery, resource discovery, bandwidth discovery and topology discovery. The discovery service manager 3 sends requests for each phase of discovery to the discovery agent 7, and receives responses containing information gathered from the network element. These responses may be stored in the database 5 for use by the discovery service manager or by other services and applications.

The discovery agent 7 services requests from the discovery service manager 3 to discover different aspects of network elements and the network, which may include the discovery of a connection to a network element, discovery of login credentials, discovery of an adaption method for a network element, discovery of the neighbours and resources of a network element and discovery of topology and OSI addresses. In one implementation, the discovery agent 7 sends requests to individual discovery worker tasks which may include a fingerprint worker 9, neighbour discovery worker 11, resource discovery worker 13, OSI address mining worker 15 and topology discovery worker 17. The OSI address mining worker 15 and the discovery worker 17 may also use OSI topology tools 19 and topology tools 21.

The discovery agent 7 may maintain information used by the discovery workers and may interface to other information managers in the system to acquire and maintain that information. This data may advantageously be used to decrease the number of login attempts and adaption methods used while discovering the network, and thereby to reduce discovery communications traffic. (An adaption method is the set of commands required to accomplish a set of high-level tasks in order to manage operations on a network element.) This information may include a list of available connection methods, a list of user credentials for logging into NEs, and a list of available adaption methods for communicating with the NEs. Each item in the list stores heuristic data on how that item has been used. The heuristic data may include an indication of how often each item in a list is used, how often it was successfully used and how often unsuccessfully used. For example, to indicate the relevant success of different data, the data may be sorted such that the most frequently successful item is placed first in the list and the least frequently successful item placed last. The items in the list may be used sequentially until either one item is successful or the list is exhausted. As each item in a list is used, its heuristic data is updated.

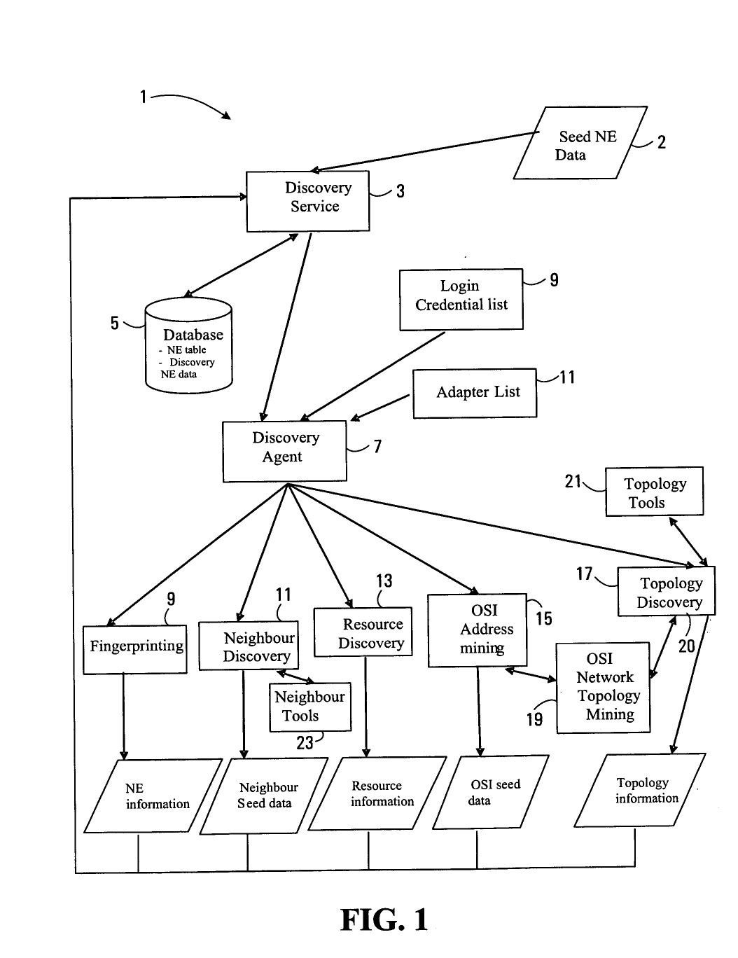

FIG. 2A shows an embodiment of an access protocol list or data structure which may be used by the discovery agent 7. Referring to FIG. 2A, the access protocol list 101 comprises a list of different access protocols 103, 105. Each access protocol item indicates a network-layer protocol for connecting with an NE. These methods may include OSI, different IP part numbers or different network layer protocols.

For each access protocol 103, 105, there is an associated credential list 107, 109 and an associated adapter list 111, 113. The credential list includes a list of user credentials that have been successfully used for the respective access protocol. The adapter list includes a list of adaption methods that have been successfully used for the access protocol. Each item in the access protocol list, the credential list and the adapter list may contain heuristic data on how often that item has been successfully used. In one embodiment, the different access protocols may be arranged in the order in which they have been successfully used. Similarly, each item in the credential list associated with each access protocol may be arranged in the order in which it has been successfully used, and likewise, each item in the adapter list may be arranged in the order in which it is successfully used. Once a compatible access protocol has been determined for a particular NE, the credential list and the adapter list associated with the access protocol is used as an initial search for user credentials and adaption methods for that NE. By starting each login attempt with the historically most successfully used credential and then successively using credential items in the list in the order of descending success, the number of attempts in finding the correct credential for the NE may be reduced. Similarly, attempting to communicate with the NE starting with the historically most successful adaption method and making any subsequent communication attempts using adaption methods in the order of most to least successful should assist in reducing the number of attempts used to establish communication with the NE.

Each time a successful access protocol, a successful credential within the credential list and a successful adaption method is found in the adapter list, each list is updated to reflect the successful items in the list, and this may include, for example, changing the order of items in the lists.

This embodiment may include a credential list for access by the discovery agent, as for example shown in FIG. 2B. The credential list 115 contains a complete list of user credentials known to the system. Each item in the list may indicate heuristic data on how often that item has been successfully used. For example, the list may be sorted from the most successfully used item to the least successfully used item. The discovery agent 7 may be adapted to access the credential list after the credential list in the access protocol list has been exhausted without finding a successful login credential.

This embodiment may include an adaption method list, as shown for example in FIG. 2C, which contains a complete list of adaption methods known to the systems. Each item in the list 117 may indicate heuristic data on how often that item has been successfully used. For example, the list may be sorted from the most successfully used item to the least successfully used item. The adaption method list 117 may be used by the discovery agent 7 once the adapter list(s) in the access protocol list has been exhausted without finding a successful adaption method.

Embodiments of each discovery worker are described in more detail below.

Fingerprinting

The fingerprint worker 9 establishes a connection to a network element, determines the management protocol supported by the network element, determines login credentials, and finally determines how to communicate with the network element. This last step is performed by determining which one of a set of known adaption methods is successfully able to communicate with the NE.

When a fingerprint request is received by the discovery agent 7, the request will contain information about how to contact the network element. The request will typically contain at least a network address, and may contain the NE's name (e.g. TID), or the address of the network element that originated the address.

As indicated above, each OSI network element has its own unique network address (i.e. NSAP). In order to complete the fingerprinting procedure, it is generally necessary to be able to communicate over the OSI network using OSI protocols in both the network and application layers. If the communication path between the network discovery apparatus and the network element to be discovered supports OSI, the discovery apparatus may establish contact with the network element using the NE's OSI address.

An OSI network may be reachable from the discovery apparatus through an IP network. A network element which resides at the interface between the IP and OSI networks may typically be referred to as a gateway network element. If the TCP/IP address of a gateway network element is known, the fingerprint worker may initially contact the gateway NE to try to determine one or more OSI addresses of network elements within the OSI network to which the gateway NE is connected. The fingerprint worker may then try to establish a connection to a network element of this OSI network over an OSI communication path using its discovered OSI address and thereby bypass the gateway NE so that the discovery apparatus can communicate with the NE using an appropriate OSI application layer protocol.

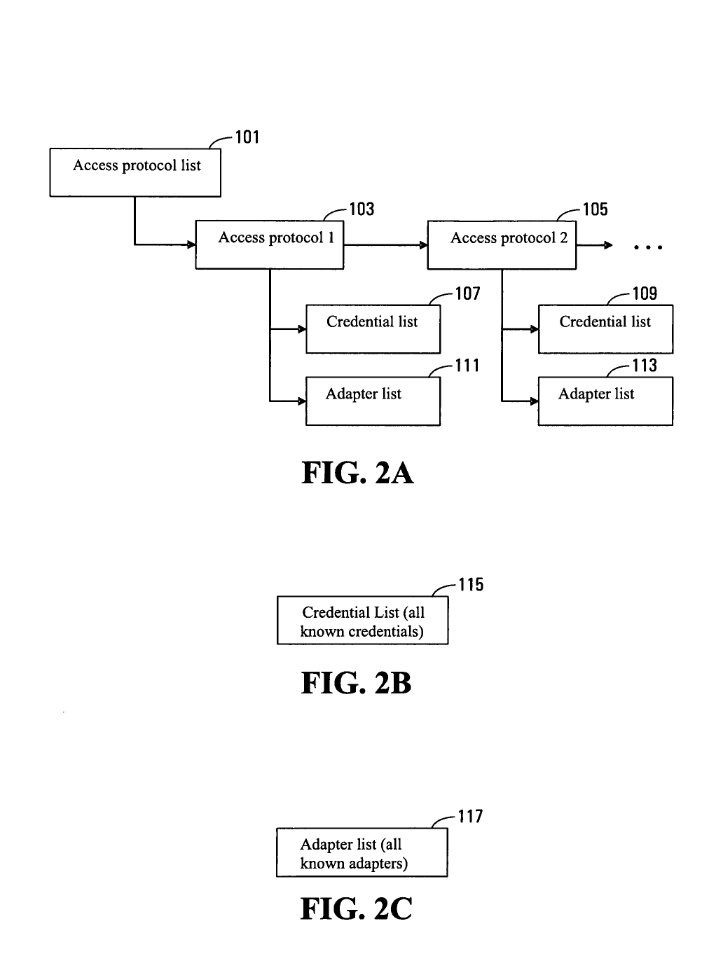

FIG. 3 shows an example of a network to which the discovery apparatus (or engine) may be connected and which illustrates an addressing scheme that may be used by the fingerprint worker 9. Referring to FIG. 3, a discovery server 201 is placed within the central office of an OSI carrier company (not shown) and is connected to a local area network 203 (e.g. an Ethernet LAN) which may also be used by other servers 205, 207 to access and manage network elements 209, 211 of an OSI network 213 via a hub 215. The hub 215 is also connected to a second OSI network 217 via an IP network 219 and a gateway NE 221. In this example, the IP network is an exclusive IP network and does not support OSI. As the discovery engine 201 is effectively directly connected to the first OSI network 213, it can connect directly to each NE 209, 211 of the network using each NEs OSI network address and the appropriate OSI protocol.

At the initial stages of discovery of the second OSI network 217, only the IP address of the gateway network element 221 may be known to the discovery engine 201. In this case, the fingerprint worker 9 of the discovery engine 201 establishes a connection (using IP) with the gateway NE 221 and proceeds through the fingerprinting procedure to determine the appropriate access protocol to communicate with the gateway NE (in this case, the access protocol corresponds to the TCP port number of the NE). Once the appropriate access protocol has been determined, the discovery engine requests information about OSI network elements to which the gateway NE is connected, and in particular OSI addresses, or at least the address of the first OSI NE to which the gateway NE is connected.

Subsequently, the discovery engine 201 attempts to establish a connection to a network element 223, 225, 227 within the second OSI network 217 via an alternative route which does not include the gateway NE 221 and which supports OSI protocols. The discovery engine may also inquire of the gateway NE 221 as to whether there any other gateways to the second OSI network which support OSI.

In the example shown in FIG. 3, the gateway NE 221 provided to the search engine the OSI address of the first connected OSI NE 223. The discovery engine transmits an OSI packet addressed to the first NE 223 and awaits a response. In the example shown in FIG. 3, a continuous OSI path exists between the discovery engine and the first NE 223 of the second OSI network and is the path 229, 231 between NEs 215, 209 and 223. Having found a direct path to the second OSI network, the discovery engine can perform a fingerprinting operation on each of the network elements contained therein, as necessary.

Alternatively, or in addition, if the gateway NE 221 provided the address of other gateway NEs to the second OSI network, the discovery engine may attempt to access the second OSI network using any one or more of the other gateway NEs.

Thus, generally when a fingerprint request is received by the discovery agent, the request will contain information about how to contact the network element. The request will typically contain at least a network address, and may contain the NEs name, (e.g. TID), or the address of the NE that the originated the address. The request is sent to the fingerprint worker 9 for processing. The response from the fingerprint worker may contain the network address of the network element and may contain the network address through which the NE was contacted. If these addresses are not the same, the address through which the NE was contacted may be a gateway network element, through which the NE may be accessed. If this condition is detected, the discovery agent tries to determine if the NE can be contacted using that NE's own network address. This is done by sending a new request to the fingerprint worker 9 using the NE's network address, and possibly other information from the original fingerprint response. If the new request is successful, the NE's network address is used to connect to the NE, instead of the gateway network address discovered originally, as exemplified in FIG. 3.

An example of a fingerprint method and algorithm is described in detail below.

Step 1: Open a Connection to the NE

The initial information to the fingerprint worker 9 contains at least one network address for the network element. The network address may be an IP address or an OSI address contained in the “seed data”, a previously discovered IP address and/or an OSI address, or the address may be the “source NE” address, i.e. a previously discovered network address of the NE that provided this NE's address.

If the seed data or the previously discovered address is an IP address, the fingerprint worker tries to open a connection to the IP-supported NE and tries to fingerprint the NE in order to determine its OSI address if it also supports OSI and/or to determine if it is connected to an OSI network and serves as a gateway NE. Where the seed data or the previously discovered address is an OSI address, the fingerprint worker tries to connect to the NE directly using its OSI address. If the address is that of the “source NE”, and it is determined that the NE's address provided by the source NE does not work, the fingerprint worker may try to connect to the NE through the source NE address.

Each available address is used in turn, as necessary to open a connection to the NE until a connection has been established. In opening a connection, each available address may be applied in the following order:
(1) the “seed data” address;
(2) the previously discovered IP address;
(3) the previously discovered OSI address; and
(4) the “source NE” address.

When TCP/IP addresses are used, a port number must also be determined if it is not already known, so that the message is applied to the correct application at the network element. Typically, the port number is a two-byte number which is assigned to a particular application residing on the IP supported NE (rather than a physical port number) and the application addressed by the discovery engine is preferably one that will yield information about the OSI network to which the NE is connected. As described above, a list of port numbers may be obtained from the access protocol list stored in or associated with the discovery agent 7. The port numbers from this list may be used in order until either one port number works or the list is exhausted. When the port number list is exhausted, the next address is tried, for example in the order described above. As soon as an address/port number works, this procedure stops, and the next step is initiated. If all addresses and port numbers in the list have failed, the fingerprint procedure stops.

This order of addresses serves two purposes. First, it allows the user to specify an address in preference to addresses that the sistem discovers, hence the first item in the seed address. The second purpose is to use a direct network address (items 2 and 3) to the NE in preference to an indirect NE-→PTO through a gateway NE (in the same NE, item 4). This will assist in minimizing the network traffic and processing overhead. However, the order may change to any other order, for example the order for items 2 and 3 may be reversed.

Step 2: Determine the Management Protocol

Once a connection to an NE has been established, the fingerprint worker 9 determines which management protocol is supported by the NE. For example, for an OSI supported NE, available management protocols include TL1 and SNMP (Simple Network Management Protocol) and CMISE (Common Management Information Services Element), for instance, and possibly others, and the fingerprint worker tries each management protocol in turn until either one is successful, or all fail.

In determining the management protocol a command is sent to the NE using each known management protocol until one command succeeds.

Step 3: Determine the Login Credentials (User ID and Password) to be Used

Once an appropriate management protocol has been determined, the fingerprint worker determines the login credentials of the network element to enable the discovery engine to communicate with the NE. This step may use login credentials from three possible sources, and they may be tried in the following order:
(1) the previously discovered login credentials for that network element;
(2) previously successful login credentials from the access protocol list, for example as shown in FIG. 2A; and
(3) the complete list of known login credentials, for example as shown in FIG. 2B, which may be maintained by the discovery agent 7.

As described above, each credential list in the access protocol list and the complete credential list may be sorted in order from the most successful item to the least successful item, and the fingerprint worker may try each item in that order (with the most successful being tried first). The login credentials are tried by attempting to log into the NE using the management protocol type determined in the previous step and the login credentials. If there is a successful login, as for example determined by the discovery engine by detection of an expected response from the NE, the determined login credential for that NE is recorded. The login credentials heuristic data may also be updated and the results stored in the access protocol list and/or the complete credential list. The user ID may be left logged into the network element for subsequent steps. If no login credentials could be used to log into the NE, the fingerprint procedure stops.

Step 4: Select an Adaption Method Appropriate for the NE Even though the management protocol has been determined (i.e. in Step 2), each manufacturer, type of NE and software release may have a different command set and a set of responses. The discovery engine provides different adaption methods for different command sets and sets of responses that are to be discovered. Each adaption method supplies a method to determine if the NE supports its command set and set of responses. This is performed by attempting to use certain commands that will uniquely identify the manufacturer, the type of NE, and the software release used by the NE. If these commands are successful, then the appropriate adaption method has been determined. In one embodiment, two lists of adaption methods are tried, and may be tried in the following order:
(1) the list of adaption methods from the access protocol list, for example as shown in the embodiment of FIG. 2A; and
(2) the complete list of all known adaption methods, as shown for example in FIG. 2B.

As described above, each of the lists may indicate the relative historical success of each method listed and for this purpose, each method in the list may be sorted in the order from the most successful method to the least successful. In selecting an appropriate adaption method, the fingerprint worker may try each item in a list in the order of descending success. Once an adaption method is successful, or both lists have been exhausted, the fingerprint procedure stops. If an adaption method is successful, the adaption method is recorded for that NE. The heuristic data for the adaption method may also be recorded and the appropriate adapter list in the access protocol list and/or the complete adapter list updated accordingly.

The results of the fingerprint worker which may include the address, management protocol, login credentials, and adaption method for the network element, are reported to the discovery agent 7 for further processing, and for reporting to the discovery service 3. In this way, the fingerprint worker discovers the identity and type of NEs on the network.

Neighbour Discovery

Network elements may contain information about other network elements with which they have communicated, and this information may be accessed and retrieved using appropriate application layer commands. Embodiments of the present invention access and retrieve this information, if available, and use this information to discover additional OSI supported network elements on the network. Embodiments of the methodologies used to acquire this information may be collectively referred to as “neighbour discovery”, although the other network elements whose information is to be discovered may not be a direct neighbour of the queried NE or even a neighbour in the same OSI network area. Accordingly, in this context, neighbour simply means a network element whose information is stored in another network element.

As the discovery of neighbour NE information requires messaging at the application layer, the appropriate adaption method for the particular NE is required, and therefore, if the adaption method is initially unknown, it must be determined first, for example by performing a fingerprinting procedure on the NE, for instance as described above.

Referring again to FIG. 1, embodiments of the neighbour discovery worker 11 use the NE's adaption method to gather a list of addresses and/or names of other NEs stored at the NE. This is achieved by sending one or more commands to the NE using the appropriate adaption method (i.e. management and command protocol). The commands may be grouped together and referred to as “neighbour tools” 23. The list of addresses and/or NE names discovered by this process is then sent to the discovery service 3 as potential new data (e.g. seed data) for further discovery (e.g. fingerprinting). Embodiments of implementations of neighbour discovery is described below.

Neighbour Tools

In an OSI supported network element, names and/or addresses of other NEs may be stored in an NE TARP cache and/or an NE routing table. The NE names and addresses are sometimes available from the NE TARP cache or the routing table using the TL1 management protocol.

NE TARP Cache

TL1-managed NEs are uniquely identified in a network by a TL1 target identifier (TID). A TID serves as the common name of a TL1 network element and is used at the application layer to identify the NE for the purposes of TL1 messaging. In an OSI network, network layer routing acts on CLNP (Connectionless Network Protocol) or NSAP addresses in order to forward messages to their destinations. Accordingly, TID's must be mapped to the corresponding CLNP addresses (NSAP's) in order to communicate to a remote NE across an OSI network.

A TID to address resolution protocol (TARP) is employed to perform and maintain these mappings. TARP maintains a list of TID's and their corresponding NSAP's in a cache on each NE that implements TL1 over OSI. For example, a TID is used when a TL1 message is posted from a GNE to another NE. When an NSAP is required for communication to a remote TL1 entity, a local TARP data cache is consulted for a match. As specified by the protocol, the TARP cache is generally populated dynamically on an as needed basis and is not guaranteed to contain a complete list of TL1 NEs in the network. Furthermore, there is no requirement that the individual entries persist in the cache indefinitely. TARP implementations commonly age out unused entries as a means of conserving memory.

TL1 network elements may provide a command to view the current contents of the TARP data cache. The command, if offered, is intended only as a diagnostic or troubleshooting command. However, embodiments of the present invention exploit the ability to access the TARP cache and use this command to discover the presence of other TL1 NEs in the network and may do so by means of an NE TARP cache retrieval and processing tool. This tool is adapted to send appropriate TL1 commands to a given NE in response to which the NE causes the contents of the TARP cache to be transmitted over the network to the discovery engine. Each TID and its corresponding network address (NSAP) retrieved from a TARP data cache query is interpreted as signifying the presence of another NE in the network. This information is passed from the neighbour discovery worker 11 to the discovery service manager 3 for use in further discovery processes such as identifying further characteristics of the NEs using the fingerprinting procedure.

Since the TARP data cache of each NE may contain a different list of TID/NSAP mappings or data to those of other NEs, querying the TARP data caches of the NEs discovered in the TARP data cache of any one particular NE may further extend the list of discovered devices. Once the discovery engine has discovered a list of NEs in a TARP data cache, embodiments of the present invention may query one or more of these discovered NEs to retrieve the contents of their respective TARP data caches using the appropriate adaption method which may be discovered by implementing a fingerprinting procedure, as necessary.

NE Routing Table

OSI supported network elements may include a routing table that contains a list of NEs which is used by the network element at the network layer to forward data traffic to its destination. Embodiments of the present invention retrieve the contents of the routing table in order to discover other NEs on the network.

For example, SONET/SDH (Synchronous Optical Network/Synchronous Digital Hierarchy) network elements serve as OSI intermediate system routers over the SONET/SDH data communications channel (DCC). In this capacity, NEs are capable of forwarding management messages from one DCC link to another to enable both NE to NE and NE/network management communication. Industry standard GR253 specifies that NEs implement the IS-IS (intermediate system to intermediate system) routing protocol to perform their network layer routing function. The IS-IS routing protocol is a protocol by which NEs on a network broadcast their presence to other NEs together with other information about themselves such as NE type and connectivity.

IS-IS maintains a routing table used by the NEs network layer forwarding component to make optimal decisions on how to forward data traffic towards their destination. The routing table commonly contains a list of reachable network layer addresses and may contain an indication of “cost” to each destination. IS-IS ensures that the routing table is kept current and updates the table with each change in network topology. The NE routing table is primarily used for purposes internal to the network element. However, commands, for example TL1 commands, exist which make the routing table information available via the NEs management interface for diagnostics or troubleshooting. Embodiments of the present invention exploit the ability to access the routing table to discover additional network elements on the network. Advantageously, the routing table may provide two types of information, one or both of which may be used by the discovery engine to determine information about the network.

Firstly, the routing table provides a list of all other NEs in that OSI routing area. This list may be provided to the discovery service 3 to seed further network discovery. Since the routing tables are populated by a standardized protocol, independent of network element vendor or type, the information they yield is inherently multi-vendor in nature. More specifically, the NE routing tables contain a list of all intermediate system routers “seen” by the queried NE whether the devices are SONET/SDH NEs from the same vendor, SONET/SDH NEs from another vendor or different equipment entirely. As long as the equipment implements the IS-IS routing protocol and has connectivity to the same OSI routing area, it will be discovered by a routing table query.

Secondly, associated with each entry in the routing table is a “cost” metric. IS-IS requires all routers to assign a numerical cost to each link they advertise. The total cost to a network destination is the mathematical sum of each individual link comprising the path to that same destination. A cost value provides a measure of how near or far a network destination is from the NE. Embodiments of the discovery engine may use this information in determining and verifying network topology between various network elements.

Embodiments of the neighbour discovery worker may implement any other available discovery tools to access and retrieve information about other NEs stored or contained in any given OSI supported network element. Generally, the address and/or name of each network element discovered by the neighbour discovery worker 11 is passed to the discovery service manager 3 for further processing by the discovery engine.

Resource Discovery

OSI supported network elements may store information about their resources that may be accessed and retrieved using appropriate application layer commands. Embodiments of the present invention use the appropriate adaption method to retrieve this information for possible use by the network discovery engine. In the embodiment shown in FIG. 1, this task is performed by the resource discovery worker 13 which is adapted to transmit appropriate commands which cause the network element to provide resource information to the discovery engine. In this embodiment, the resource discovery worker 13 passes the retrieved data to the discovery service which will cause the data to be stored appropriately in a database, for example database 5, or another database, for future use. The resource information may include one or more physical characteristics of the network element which provide a physical description of the NE. For example, the resources may include but are not limited to one any one or more of the following: the number of cards, card type, their configuration, the number of ports on a card, the port type (e.g. OC12, OC48, OC192, etc.), physical properties of the fibres connected to each port.

This information may be useful in further identifying characteristics of the network elements on the OSI network and may also be used in the discovery of the topology of the network, i.e. the physical location of a network element in relation to others. For example, in determining whether a particular network element can be immediately adjacent another network element, certain characteristics of the network elements must be the same or compatible. Accordingly, knowledge of these characteristics can be used to assist in verifying whether or not a particular network element can be an immediate neighbour of another.

OSI Address Mining

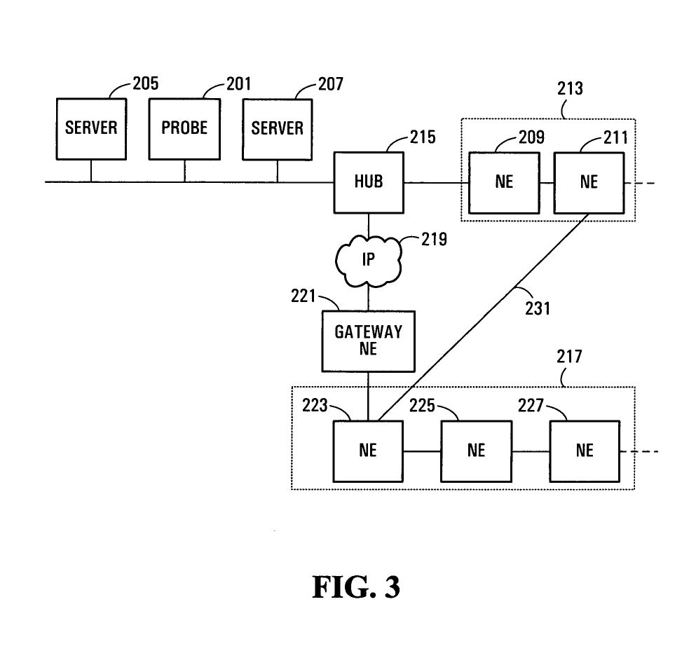

Network elements within an OSI network may be grouped according to area. Network elements belonging to the same area have a common area network address which is stored and is part of the NSAP address of each OSI network element. At present, there are a number of different levels at which an NE may be set to read addresses. A level 1 NE is set only to read the unique identifier in the NSAP and therefore can only communicate directly with other NEs within the same area. Level 2 NEs are set to read both the area addresses and unique identifier in the NSAP and can therefore communicate with level 1 NEs, i.e. NEs in the same area, and level 2 NEs in other areas. Thus, if a network element is a level 1, the network layer information that it can receive via IS-IS messaging is restricted to information relating to other NEs within the same area. On the other hand, if an NE is a level 2, it can receive IS-IS messaging from other NEs within its associated area and in addition IS-IS messaging from network elements within other areas. However, the NE will not have access to IS-IS messaging from NEs having only a level 1 address which is different from the level 1 address of the present NE but which are in the same level 2 area. An illustration of this arrangement is shown in FIG. 4. Referring to FIG. 4, an OSI network includes different level 1 areas 303, 305, 307. One network element 309, 311, 313 in each area operates at a level 2 NE. The other network elements 315, 317, 319 in their respective areas run only as level 1 nodes. In this case, network element 309 in area 303 executing the level 2 functionality can receive level 1 IS-IS information from all network elements 315 within the level 1 area and also IS-IS information from each of the network elements 311, 313. However, the network element 309 cannot receive IS-IS messaging directly from level 1 address NEs in the other areas 305, 307. In the configuration shown in FIG. 4, each level 2 NE 309, 311, 313 is connected to an Ethernet network 321 which may for example at least partially reside in the network management office of a carrier. A management server 323 is connected to the Ethernet network to manage each of the OSI network areas 303, 305, 307. A network discovery engine 325 is also connected to the Ethernet 321.

In one particularly advantageous implementation, the discovery engine 325 is configured to receive IS-IS messages from network elements to which it is connected. For example, to receive IS-IS messages from the level 1 area 303, the discovery engine sets its area address to be the same as the area address used in area 303. In this way, the discovery engine can receive and store routing information that describes the process area 305. In addition, the level 2 network elements 311, 313 in the other areas exchange level 2 routing information allowing the discovery engine to discover all the nodes running as level 2 in the routing domain.

In order to automatically receive information contained within the IS-IS messaging from the level 1 NEs within the other areas 305, 307, the discovery engine sets its area address to each of the level 1 addresses of the other areas 305, 307. In this way, the network discovery engine can acquire the NSAP addresses of all network elements within each of the areas 303, 305, 307.

Initially, the discovery engine 325 is configured as a level 2 (and as a level 2 with areas 309, 311, 313). This will allow the acquisition of level 2 routing information for the domain as well as the routing information for the area discussed above. The discovery engine sets its area addresses to the area addresses of the other remining areas. After the discovery engine has acquired all available NSAP addresses of the network elements within one area, the discovery engine may configure itself as a level 1 NE in another area by setting its NSAP address to that area address. Again, once the discovery engine has acquired all of the available NSAP addresses of network elements within that area, the engine 325 may configure itself as a node within another area so that it receives all available NSAP addresses of NEs within the area.

In embodiments of the invention, this function of acquiring OSI network addresses of network elements within one or more areas using IS-IS messaging may be implemented by the OSI address mining worker 15, and may be initiated by the discovery agent upon request of the discovery service.

The OSI address mining worker 15 may use OSI network topology tools 19 to create a list of OSI (NSAP) addresses and/or TID's that can be derived directly from the OSI network. Specifically, the mining worker gathers TID's and OSI addresses for all NEs in the top cache, OSI addresses for all NEs in the server's level 1 area, and OSI addresses for all adjacent nodes. The TARP is then requested to resolve each of these addresses into a TID. The resulting list of NE addresses and possibly TID's are sent to the discovery service as potential seed data.

In one embodiment, the network discovery engine may be adapted to automatically configure itself as a network element on an OSI network. The discovery engine configures itself as a level 2 network element so that on connection to the network it receives and reads the area address portion of the NSAP address of each network element on the OSI network, and may record each area address. Thereafter, the discovery engine announces its presence as a network element belonging to a particular area and thereby receives NSAP addresses from each network element within that area via IS-IS messaging. Thereafter, the discovery engine announces itself as a network element in another area and thereby receives NSAP addresses of network elements within that area.

Topology Discovery

In addition to discovering the identification and information about network elements on an OSI network, embodiments of the discovery engine discover the topology of the NEs.

Topology discovery may be implemented by the topology discovery worker 20 which may act upon requests for topology discovery from the discovery service. The worker issues commands (grouped under topology tools 21) to network elements to discover topology information and may also use OSI network topology tools 19 to discover additional topology information. Each piece of topology information is processed in turn allowing potential neighbours and links to neighbours to be identified or rejected. After all relevant data has been processed, the topology picture can be further refined by direct user input, if required.

Topology Tools

The topology tools are a collection of mechanisms for extracting information useful to topology discovery from the NEs using an appropriate application layer protocol such as TL1. The information extracted may not always be explicitly or directly related to topology, but when pieced together can be used to build the topology. Examples of topology information that can be provided via TL1 is described below.

Generally, every OSI NE supports TL1 commands which provide varying levels of topology information. The level of information available depends on the NE type. For example, for BLSR nodes in particular, useful information may be stored in the squelch table which may be made available through TL1.

Section Trace

A section trace provides a means of determining which network elements are at either end of a section or link. Some network elements provide commands, such as TL1 commands to set and retrieve the value of the section trace identifier which is normally one byte. The section trace byte can be set to a specific value at one end of a section between two NEs and queried at potential far ends to match the two ends of a given section. Embodiments of the present invention may use the section trace to assist in determining the topology of a network. For example, the discovery engine may send an appropriate TL1 command to an NE to retrieve any section trace byte that may have been previously set. If it determines that a section trace byte has been set, the section trace is retrieved and stored in the discovery engine for comparison with other section trace bytes retrieved from other NEs. The discovery engine may then query other potential candidate NEs for their section trace byte and if a match is found, the discovery engine determines that the two NEs are connected at either end of a section or link and are immediate neighbours. If the discovery engine determines that the section trace byte has not been set at the queried NE, the discovery engine may send appropriate commands to set the section trace byte value and thereby cause the NE to forward the section trace to the network element at the other end of the link. The discovery engine may subsequently query other potential candidate NEs for their section trace and a match indicates to the discovery engine which NE is connected at the other end of the link and the relationship between the two NEs is recorded.

Facility Characteristics

A facility is defined a physical link joining two NEs and each facility has at least one and commonly many attributes which must be in agreement between the near end and far end of the link. Embodiments of the discovery engine may send appropriate commands to retrieve one or more attributes of a facility connected to a given NE and record the attributes for comparison with the attributes of facilities retrieved from other NEs. The discovery engine may use this information to assist in verifying whether or not two NEs are connected. For example, where the attributes of a facility retrieved from two NEs differ, the discovery engine may determine that one or more particular ports of the NEs are not connected and therefore the discovery engine can use this information to eliminate potential matching ends. While matches between facility attributes of NEs may not be conclusive of their connectivity, the discovery engine may use this information to maintain the NEs as potentially matching and verify whether or not they are connected by using additional tests. Examples of facility characteristics that may be applied include but are not limited to physical attributes such as wavelength, optical power (e.g. the laser power setting), the bandwidth of the link which may include the number of channels (e.g. OC12, OC48, OC96, OC192, etc.), protection (e.g. the type of protection scheme or its characteristics) and timing (e.g. the timing of transmission and receipt of frames at the end of a facility, and clock rate).

Port Connection Signature

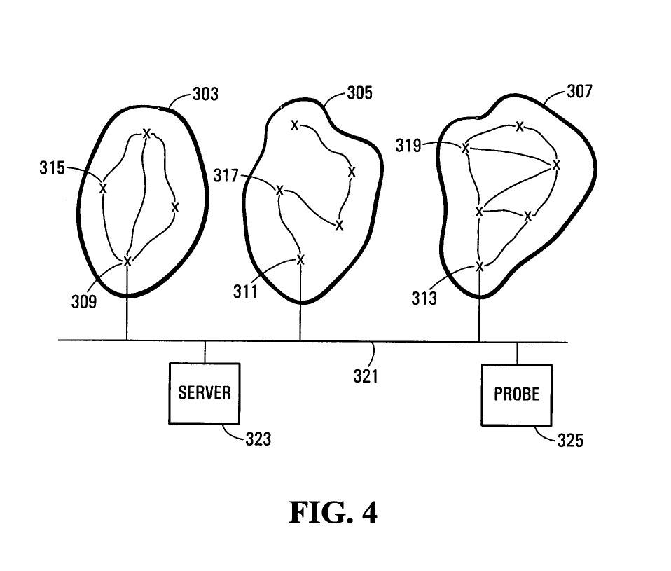

Embodiments of the discovery engine and method may use the pattern of bandwidth allocation as a means to assist in verifying a connection between two NEs. The pattern of bandwidth allocation at the near-end of an optical link is often the same as that at the far end. For example, an optical link typically has a plurality of channels for carrying data traffic. For example, on an OC12 optical link carries 12 channels, and OC48 link carries 48 channels, etc. All channels or fewer than all channels may have been provisioned to carry traffic, and the pattern of bandwidth allocation is an identification of which channels have been provisioned to carry traffic and which have not. For example, with reference to FIG. 5, in an OC12 link, channels 2, 5, 6, 8 and 10 may have been provisioned to carry traffic and this would be the pattern of bandwidth allocation. Embodiments of the discovery engine and method may send appropriate commands to a network element to retrieve and store the pattern of bandwidth allocation for use in comparison with the pattern of bandwidth allocation determined from other NEs. Non-matching patterns may be used to eliminate potential matching ends of a specific link.

Path Trace

Embodiments of the discovery engine and method may use an identifier at an NE which indicates a path terminated by the NE to assist in topology discovery. The identifier uniquely identifies a path between two NEs which terminate the path at either end and may either be previously set and accessible by the discovery engine or the discovery engine may set the identifier as part of the discovery process. Typically, the identifier is only stored at the NEs which terminate the link and not at any intervening NEs. Furthermore, the identifier does not normally identify any NEs between opposite ends of the path.

For example, in OSI, the identifier is referred to as a path trace, and most NE types which terminate solid paths provide TL1 commands to set and retrieve the path trace value. Path traces only available for a given network element for that or those paths which terminate at the NE.

Embodiments of the discovery engine may send appropriate commands to an NE to retrieve its path trace values, if any, and may store the retrieved values for comparison with path trace values retrieved from other NEs.

The discovery engine may then compare retrieved values from potential candidate NEs and determine which NEs terminate a particular path when a match is found. If as a result of a path trace query it is determined that a path trace has not been set, the discovery engine may cause the path trace to be set at an NE and thereafter query other NEs for a match to determine which NE terminates the other end of the path.

The path trace is normally manually set when provisioning a network and each identified path typically has an assigned bandwidth. The path trace (or path identifier) is normally used by the NE to track the available bandwidth of different paths which it terminates. Embodiments of the discovery engine make use of this feature to determine information on the connectivity of network elements for topology discovery.

User Specific Naming Conventions

NE operators sometimes have specific naming conventions which they use when commissioning NEs, which may be indicative of a relationship between NEs. For example, certain bits of a target identifier (TID) of an NE may include a naming convention such as a name or label selected and applied by an NE operator. The name or label may for example indicate the geographical location of the NE or an identifier which indicates one end of a given facility.

Embodiments of the discovery engine and method may be adapted to send appropriate commands to retrieve specific naming conventions from an NE and store this information for comparison with similar information retrieved from other NEs. The discovery engine may use the results of comparisons to determine relationships between various NEs which may assist in determining the network topology. For example, NEs having a common geographical identifier provides an indication of the geographical proximity of NEs. Similarly, matching names used to identify the end of a given facility indicates that two NEs are connected.

Selective SDCC Disabling

In cases where an immediate neighbour of a given NE is known, but not which facility connects the NE to its neighbour, embodiments of the discovery engine and method may be adapted to selectively turn off potential connecting facilities and analyze the effect. For example, the discovery engine may cause a selected data communications channel at an NE to be turned off and if the neighbour becomes unreachable as for example may be determined by attempting to transmit a signal from the NE to its neighbour, this provides an indication that the disabled data communications channel is on the facility linking the nodes. In another embodiment, a trace route to the neighbour before and after a selected SDCC is turned off may be analyzed and if the trace route changes, this provides an indication that the disabled SDCC is on the facility linking the NE to its neighbour. When disabling selective SDCC's, care should be taken not to isolate the NEs under investigation from the discovery engine or possibly from any other management system. Specifically, if a communications item is disabled which results in the discovery engine being unable to communicate with the node, then the discovery engine cannot re-enable communications with the node.

OSI Network Topology Tools

A network of OSI supported NEs such as SONET/SDH NEs may use the OSI suite of communications protocols to communicate over their communications channels. Embodiments of the discovery engine and method may implement one or more features of a compatible OSI protocol suite and use information obtained from the OSI network layer to obtain detailed information from the underlying network that the network elements themselves may not be able to explicitly provide through that application layer interfaces. In the embodiment shown in FIG. 1, this function is implemented by the OSI network topology tools section of the discovery engine. Examples of existing network layer protocols that are implemented by SONET NEs are the ISIS routing protocol (IS010589) and the connectionless network layer protocol (ISO 8473). The OSI tools may actively participate in the OSI network layer with the NEs they are discovering and make their own inferences on network composition and topology.

Examples of features of the OSI protocol on which the OSI discovery tools may be based include but are not limited to OSI trace route, link state PDU (protocol data unit) and route recording utility.

The link state PDU identifies each immediate neighbour NE to which a given NE is connected and is stored in that NEs database. NEs within a given area provide their link state PDU's to other NEs within the same area so that each NE contains a complete description of the NEs within its area and their respective immediate neighbours. This information is used by each NE for routing purposes and is not externally accessible and cannot be obtained by application layer commands.

Level 2 type NEs include, in addition to a link state database for its associated level 1 NEs (i.e. NEs within the same area), a level 2 LSP database which lists all level 2 NEs in the network and their level 2 immediate neighbour NEs.

Embodiments of the discovery engine may be configured to effectively become an NE in a given network area and so that it receives the LSP's from other NEs in the same area and records the LSP's in its memory, which thereby serves as the discovery engines LSP database. In contrast to conventional NEs, where the LSP database is inaccessible, the discovery engine is conditioned to access the LSP information from its database and thereby retrieve the network addresses of other NEs in its area. As the LSP's provide information about any given NEs immediate neighbours, the discovery engine may use this information to determine the topology of the network.

If the discovery engine is capable of connecting to more than one level 2 NEs e.g. it shares an ethernet not two or more level 2 NE's in different areas the engine may configure itself as an NE in the network area of another level 2 NE and receive and access LSP's from NEs in that other area. This process may be repeated for each level 2 NE to which the discovery engine can be connected to discover topology information on each different area.

Route Recording Utility

Another OSI network layer utility that may be used by embodiments of the network discovery engine is the route recording utility. The route recording utility is a packet that is transmitted from an NE and addressed to a destination NE and which records the network layer address of each NE (e.g. router) through which it passes to its destination. The header size is normally limited to 256 bytes, which limits the space in which NSAP's can be recorded to less than 256 bytes. For example, assuming NSAP's have a length of 20 bytes, only about 10 NSAP's would be recorded. Some NEs might not implement the recording option. The route recording packet can be set at two different levels: loose and complete. If set to loose, when the packet meets a node that does not provide the recording option, the packet continues and records the next packet that does, providing there is sufficient space in the header. If the complete option is set, when the packet meets a node that does not implement the recording option, the packet fails and the node returns a failure notice.

Embodiments of the discovery engine may use the NSAP addresses of NEs recorded in the returned route recording packet to assist in determining the topology of the network.

OSI Trace Route Utility

The OSI trace route utility is dependent on the pdu lifetime control function provided in the OSI network layer protocol. The lifetime control function is intended to ensure that no packet lives in the network for ever. It is possible that one or more Intermediate System nodes in the network may, due to bugs (or flaws) in the implementation, cause a packet to be forwarded in a loop for some period of time (possibly for ever) and never reach its destination. To prevent this, each time a packet is forwarded by an Intermediate System, its lifetime is decremented, with the idea that when the lifetime reaches zero, the packet is to be discarded and an Error Report (ER) packet should be generated. The lifetime is set to some fixed number for each data packet that is sent. It is a one byte value, and so the maximum is 255. That means it will only be forwarded by 255 Intermediate Systems, and then be discarded (regardless of where it is). A side-effect of the packet being discarded is that the system that discarded the packet, has to generate an Error Report packet to send back to the originator. The transmitting NE can thereby determine where the failure occurred.

Embodiments of the present invention use the trace route facility to identify network elements on the network and their topological relationships. The trace route packet includes a lifetime field which, when trouble shooting, is generally set to a maximum value. Embodiments of the present invention use the lifetime field to control the number of NEs that the trace route packet is permitted to visit on its path to a destination NE before the packet expires and an error report issued. By varying the lifetime field, the trace route can be controlled to expire at different (e.g. consecutive) NEs on route to the destination NE so that the error reports contain the addresses of each NE on a particular path. The lifetime field can be controlled so that the trace route eventually reaches the intended destination NE, in which case all of the NEs between the transmitting NE and the destination NE can be identified.

Embodiments of the present invention may extend this utility by transmitting trace route packets each with different lifetimes along different paths to the same or different destinations and may use the information contained in the error reports or echo replies to obtain network layer addresses of NEs within the network and their topological relationships. Examples of embodiments of the OSI trace route methodology for NE identification and topology discovery are described in more detail below.

In one embodiment, network layer echo request packets are issued to a particular destination with varying lifetime values, starting with a small value (e.g. one) and increasing the lifetime until the destination node is reached. Error report (ER) PDUs should be returned from the intervening nodes as the packets expire on route. Advantageously, this concept should be functional in most if not all OSI networks.

Computational Complexity

The relevant resource in this functionality is network bandwidth, and so the complexity is computed as a function of the number of packets (either ERQ, ERP or ER that are imposed on the network). It is estimated that the complexity of gathering the information will grow more than linearly with the number of nodes being investigated and less than the square of the number of nodes.

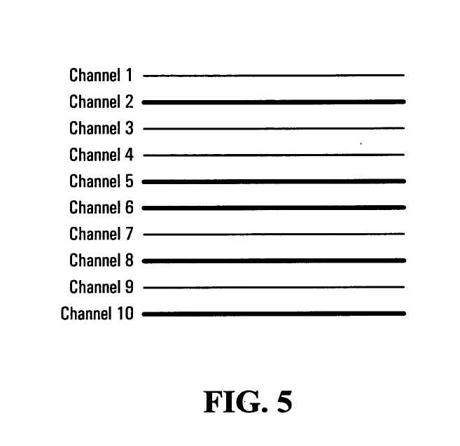

An example of a method of discovering network topology using the trace route functionality will now be described with reference to FIGS. 6 to 10.

FIG. 6 shows an arrangement of nine network elements labelled “a” to “k” whose topology is to be determined. In this example, the discovery server 401 has separate connections to network elements a, b and c.

Distance Sorting and String Discovery

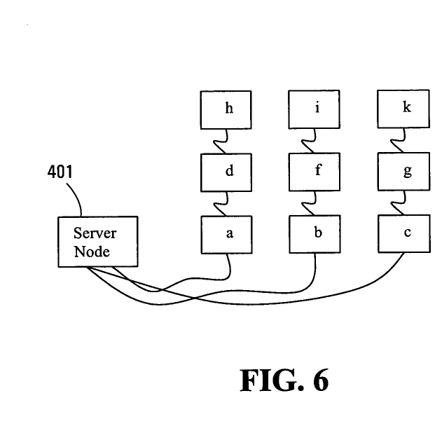

The lifetime value set in an ERQ packet allows the distance to the node to be determined when the ER packet returns with the original ERQ as the data portion. This allows the nodes in a network to be sorted based on the distance from any single node. A first part of a topology discovery method generates a set of strings of nodes (i.e. addresses) through the network from which neighbour relationships may be obtained. In the first part, the paths are discovered that a packet would normally take to reach a specified destination. (The “normal” path is that which is calculated by each node that routes the packet according to its routing protocol or algorithm, such as the “Shortest Path First” routing protocol.) The second part of the method generates the cross member strings of nodes. An example of an algorithm which performs the first part of the method is shown in FIG. 7.

Optimization Considerations

If the algorithm were to choose nodes at random and perform the trace route functionality, the probability of choosing any particular node to which to trace route is about equal. In the example of FIG. 6, the probability of choosing any particular node is 1/n (i.e. 1/9, since there are nine nodes). The probability of choosing the closest node to the probe node (e.g. discovery engine) is approximately equal to choosing one that is far away. The algorithm discards strings of nodes which are initial sub strings of other strings in the database, and so the shorter trace routes would eventually be discarded and the longer trace routes are discovered (i.e. finding the shorter strings first would be wasted effort since they are redundant (and therefore may be discarded) when the longer strings are found, as the shorter strings are part of the longer ones).

In order to reduce the number of trace route functions that are required to determine the nodes on a particular string, as a first step, network layer echo request functions are performed to determine the furthest nodes from the probe server. This step may be performed by setting the initial lifetime value to a relatively high or maximum value and sending an echo request to each node in turn. As each echo request passes through a node, the lifetime value is decremented by one and therefore the lifetime value returned in the echo reply packet allows the distance to each node to be computed. Specifically, the distance is equal to the lifetime starting value in the echo request packet minus the lifetime value contained in the echo request data recorded in the echo reply packet. Once the relative distances of the nodes have been determined, an untried node list is generated containing nodes ordered by distance with the furthest nodes being placed first in the list and nodes which are the same distance away from the probe server being ordered arbitrarily. Thus, in the case of the network shown in FIG. 6, this step generates the following: “untried node list”=“{h, k, i, f, d, g, a, b, c} (furthest to closest).

From this list, OSI trace route functions are then performed to determine the various node strings.

The furthest node (or if there is more than one, then one of the furthest nodes) as determined in the previous step is selected as the address to which further echo requests packets are transmitted and the lifetime of the first echo request packet is set to one to determine the first node in the string connected to the furthest node and then, for each subsequent echo request, the lifetime is successively incremented by one until the furthest node is reached. As the distance of the selected furthest node has already been determined, it is only necessary to set the lifetime of the last echo request packet when performing trace route to a number that is one less than the determined distance of the furthest node in order to reduce the number of echo requests required to determine the complete string. Thus, for example in computing the h_string, it is necessary only to transmit two echo request packets to determine the complete string, h, d, a.

Thus for example in performing trace route the h_string may be computed first which produces:
h_string=(h, d, a)(furthest to closest)

The nodes in the h_string are removed from the untried node list, which then becomes:

untried nodes list=(k, i, f, g, b, c)(furthest to closest)

Once again, the furthest node from the untried nodes list is selected and using trace route, the following string is generated:
k_string=(k, g, c) (furthest to closest)

The k_string nodes are then removed from the list which then becomes:

untried nodes list=(i, f, b) (furthest to closest)

Again, the furthest node is selected from the reduced untried nodes list and, using trace route, the following node string is generated:
i_string=(i, f, b) (furthest to closest)

At this point, the algorithm terminates since the “untried nodes list” is empty.

The generation of the strings of nodes (i.e. lists of addresses) involves finding all the longest possible strings. During this process, if a string is found which is a sub string of an existing (longer string) then the shorter string is discarded. This process is repeated until all the nodes are on at least one string or on an error list. It is possible that there will be initial sub strings that will be common to all strings, and the nodes that are the common sub string may be removed from the remainder of the topology probing process.

Problem nodes may be tracked and stored in a database for reprocessing. For example, once the untried nodes list is exhausted, it may be desirable to try to reconcile the nodes in the ERR and strings of nodes in the ERLDB databases.

Horizontal or Cross Strings

Embodiments of the topology probe may also find connections between the various strings found in the previous procedure which generated separate strings containing the respective furthest nodes from the topology probe identified in that procedure. For example, with reference to FIG. 6, embodiments of the probe are capable of finding connections between the strings containing nodes h, i and k. This is achieved by causing the packets to flow through the network so that these further relationships can be determined.

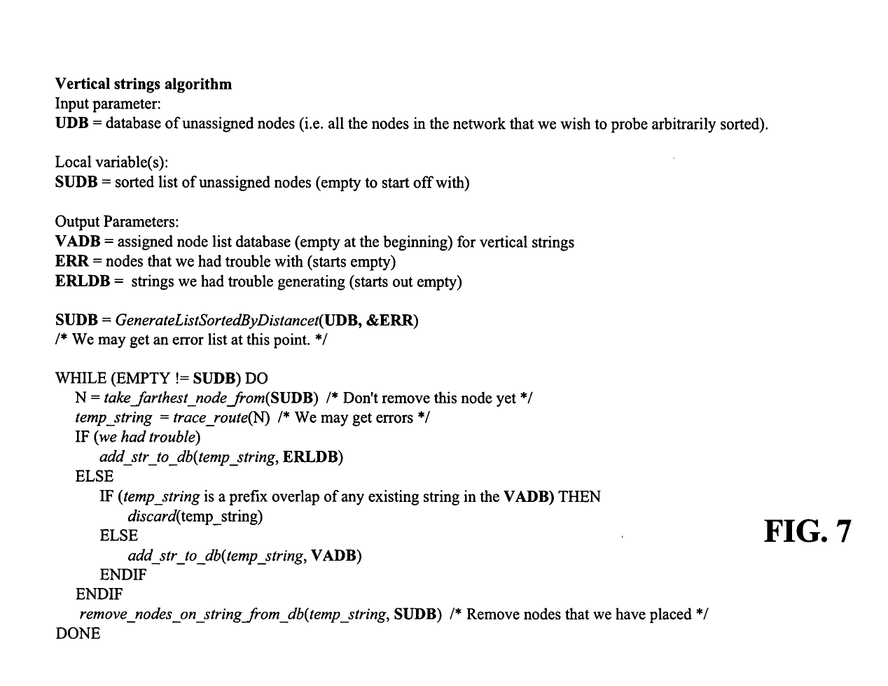

For example, with reference to FIG. 8, string_hk=(h, i, k) needs to be determined, but the location of the probe server necessarily requires the probe to generate strings that originate at the probe. Thus, in generating string_hk, the probe actually generates the string=(a, d, h, i, k). The first two elements, (a, d) can be discarded since the string (a, d, h) has been discovered previously. In this case, the probe forces packets to flow through a specific node, i.e. node “h”, in this example, on their way to node “k”. The horizontal strings are then generated a manner similar to the vertical strings method described above.

To generate the cross traces, embodiments of the invention cause packets to follow a certain path through the network or at least force packets to visit one specific node on the way to another. The inventors have devised methods within the OSI network layer to perform this function, one of which uses network layer echo function and pre-formed echo reply packets and another uses partial source routing. These methods are described in more detail below.

Network Layer Echo Function and Pre-Formed Echo Reply

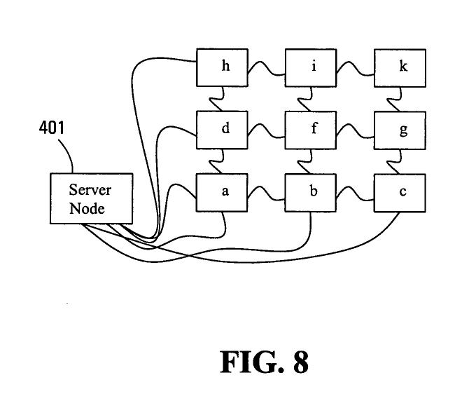

An example of this methodology will be described with reference to FIG. 8. The method involves the generation of echo request (ERQ), echo reply (ERP) and error report packets. The OSI protocol stipulates that if desired, the ERQ packet may contain in its data portion a complete ERP packet. This aspect of the protocol is intended to save the responding network entity the complexity of having to construct the ERP header. If the ERQ packet contains a pre-constructed ERP, the responding network entity is obliged to use the supplied header to issue the ERP. Embodiments of the probe exploit this aspect of the protocol to cause packets to visit a predetermined node on their way to a destination node and to determine intervening nodes between the visited node and the destination node. This technique may be illustrated with reference to FIGS. 8 and 9 in which the technique is used to find the cross trace between nodes h, i and k in FIG. 8.

Firstly, the probe, “P”, generates an echo request packet 451 in which the header 453 contains as its source the address of the server node “P” and as the destination node, node h. In the pre-formed echo reply packet 455 which is contained in the echo request packets data portion 456, the echo report packet contains as the source, the address of the probe “P”, as the destination node, node k, and a lifetime value of one.

The probe then transmits the echo request packet 451 which flows to node h. On reaching node h, which is the destination node specified in the ERQ packet's header, node h generates an echo reply packet 457 which corresponds to the pre-formed echo reply packet 455 specifying the probe as the source of the echo reply (in lieu of h) and node k as the destination node. Node h then transmits the echo reply packet 457 towards node k. When the echo reply packet 457 reaches node i, node i will detect that the lifetime field in the echo reply packet's header 459 has expired at node i (as it was set to one) and node i then generates an error report 463 (since the echo reply expired before reaching its specified destination, node k. The header 465 of the error report will contain as its destination address (e.g. NSAP) the apparent source of the echo reply, namely the address of the probe “P”, not h, and as its source address, the address (e.g. NSAP) of node i. Thus, the error report contains the identity of the first node from node h on route to node k, and this information may be recorded by the probe.

The data field 467 of the error report 463 will contain the information in the header 459 of the echo reply 457, i.e. the address of the destination node k and the source specified in the pre-formed echo reply, namely probe “P” (and this information may be useful to identify the packet when it arrives at the probe).

To determine the next node between node i and k on route to node k, the probe generates another echo request with a pre-formed echo reply which causes the generated echo reply to expire at the node which is adjacent node i and between nodes i and k, if any. This may be achieved by defining node h as the destination node in the echo request packet and in the pre-formed echo reply packet setting the source again to the probe address, the destination to node k and the lifetime value to 2. In the particular case of FIG. 8, as there is no intervening node between nodes i and k, the echo reply generated and transmitted from node h will reach the intended destination node k, and at the same time the lifetime field will expire. Depending on its configuration, node k may generate an error report if it is so configured despite receiving the echo reply as the intended echo reply destination node. If node k generates an error report, the error report will contain as its destination the source node identified in the header of the echo reply, namely the address of the probe, and will therefore be transmitted to the probe. The header of the error report will also contain as its source address (NSAP), the address of the node at which the echo reply expired, namely node k.

Alternatively, node k may be configured such that no error report is generated, since the echo reply reached the intended destination even though the lifetime value expired thereat. If, in response to the transmission of an echo request the probe receives no error report, the probe may interpret this as the echo reply reached its intended destination node and thereby deduce that the last successfully received error report was generated by the node immediately adjacent the destination node.

However, embodiments of the probe may generate echo requests that ensure that a response is received from the destination node (e.g. node k) even if expiry of the lifetime in the echo reply packet does not cause the destination node to issue an error report.

In one embodiment, use is made of a field within the header of an NSAP address which indicates that the packet is intended for a particular application when it reaches the destination node. The field (selector) is normally one byte, and for echo request and echo reply packets, the value is set to 0 so that each node recognizes the packet as pertaining only to the network layer. If the packet is intended for another layer such as a transport layer, this byte is set to a value which corresponds to the appropriate address of the application for which it is intended at the destination node. When generating the pre-formed echo reply, the value of the byte is set to a value which will not be recognized by the destination node and therefore cause the destination node to generate a report indicating non-delivery of the packet and transmit the report to the source identified in the echo reply, namely the probe.

Any other suitable technique for causing the destination node to generate and transmit a message to the probe indicating that it received the pre-formed echo reply may be used.

Partial Source Routing

Partial source routing provides the ability to specify a list of addresses (i.e. network nodes) that should be visited on the way to a specific destination. Embodiments of the probe may use this function to cause echo request packets to flow through a particular node in order to generate cross trace information.

An illustrative example of partial source routing will now be described with reference to FIGS. 8, 10 and 11. The probe generates an echo request 471 which specifies in its header 473 the probe “P” as the source node, node h as the node to be visited and node k as the destination node. The lifetime value in the header is set to the distance to h plus one. The distance to h has already been determined as 3, and therefore the lifetime value is set to 4.

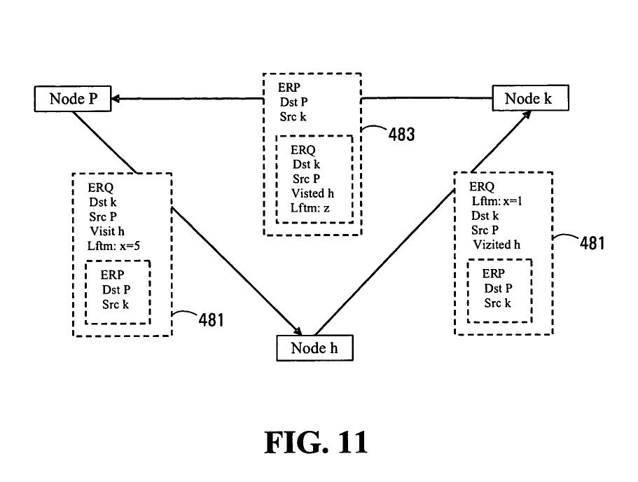

In this case, the echo request flows through nodes a, d, h to node i and at each node, the lifetime value is decremented by one. Therefore, on reaching node i, the lifetime value is 0 and node i will detect that the packet expired before reaching its destination, i.e. node k. In this case, node i will generate an error report 475 identifying itself in the header as the node at which the echo request packet expired. (In this case the source address (e.g. NSAP) in the header or the ER is that of node i.) In this way, the probe determines the identity of the node immediately adjacent node h on route to node k. Thereafter, the probe generates another echo request 481 (FIG. 11) which has a header similar to that of the previous request but with the lifetime value incremented by one so that in this case the lifetime value equals 5. Since in this example, there are no intervening nodes between i and k, the echo request will reach its intended destination, i.e node k and node k will either transmit an echo reply 483 indicating that it received the echo request packet 481, or an error report (not shown in FIG. 11), indicating that the echo reply expired at node k. In either case, the probe can determine that the node which is immediately adjacent node i on route to k is node k.

Using any of the methods described above, cross trace information can be determined by the network topology probe.

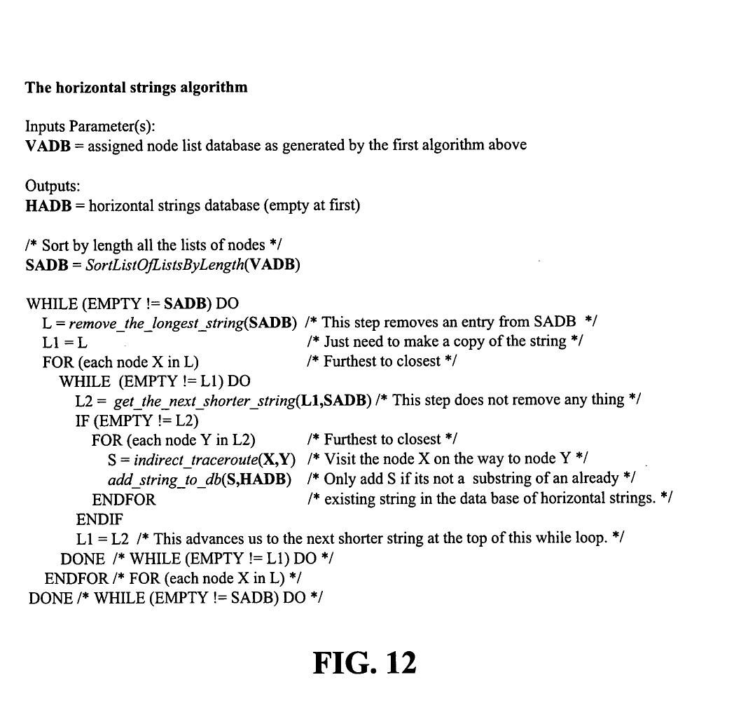

An example of a method of discovering the cross traces of a network is described below with reference to FIG. 8, and the corresponding algorithm is shown in FIG. 12.

As for the vertical strings, a few simple rules about the order of the operations may be applied in order to maximize the coverage and minimize the use of network bandwidth. Advantageously, the nodes on the longest of the strings may be used as the ‘visit’ points on the way to the nodes on the next longest strings (starting with the furthest node on the respective strings).

The vertical strings step generated the following information.
‘untried node list’ == {h, k, i, f, d, g, a, b, c}(furthest to closest)
and also the following lists.
h_string == {h, d, a} (furthest to closest)
k_string == {k, g, c} (furthest to closest)
i_string == {i, f, b} (furthest to closest)

This is where the vertical part of the algorithm terminated as indicated in FIG. 6. All the strings are the same length in this case and so the strings may be chosen arbitrarily.

However, for the purpose of illustration, it may be assumed that the longest string chosen is h_string and the next longest is k_string. The method generates cross traces via the furthest node of the longest string to the next longest string, starting at its furthest node and progressing to its nearest node, and also works through progressively shorter strings.
hk_string == {h, i, k}*
hg_string == {h, i, k, g}
hc_string === {h, i, f, b, c}
dk_string == {d, f, g, k}
dg_string == {d, f, g}*
dc_string == {d, f, b, c}
ak_string == {a, b, f, g, k}
ag_string == {a, b, f, g}*
ac_string == {a, b, c}

Strings marked with a * may be discarded immediately since they are just substrings of other longer strings. The h_string can now be removed from the strings database. Next, the longest string and the next longest string are selected and the above process is repeated. In this example, the k_string and the i_string are chosen (since these are the only strings left) and the following strings are generated:
ki_string == {k, i}*
kf_string == {k, i, f}*
kb_string == {k, i, f, b}
gi_string == {g, k, i}
gf_string == {g, f}*
gb_string == {g, f, b}
ci_string == {c, b, f, i}
cf_string == {c, g, f}
cb_string == {c, b}*

Once again, the strings marked with an * may be removed since they are substrings of other strings. At this point, the k_string may be removed, leaving just one string, so the algorithm terminates.

At this point, a set of vertical and a set of horizontal strings have been generated. The information from all these strings may now be distilled. One piece of information that can be readily derived is all the neighbours of each of the nodes, and the result, as indicated below, is essentially the link state database of the network extracted from the strings
a -- b, d; b -- a, c, f; c -- g, b; d -- h, a, f; f -- g, b, i, d; g -- f, c, k; h -- i,d; i -- k,f,h; k -- i,g;

It will be appreciated that the above-described example using the concept of vertical and horizontal connections is for illustrative purposes only, and the principles of the method may be applied and extended to any network having arbitrary connections between network elements.

The cross trace function will need more than one approach since it depends on functionality which may not be present everywhere

Acronyms

| | |
|---|---|
| ER | Error Report PDU |
| ERP | Echo Reply PDU |
| ERQ | Echo Request PDU |
| DT | Data Packet |
| LSP | Link State PDU - lists the immediate neighbours |
| | for a particular node. |
| TCP/IP | Transmission Control Protocol/Internet Protocol |
| OSI | Open Systems Interconnect. - An international set |
| | of standards. |
| PDU | Protocol Data Unit |

Definitions
Distance: In the context of networks, this is the number of ‘hops’ that a packet needs to make on its way to its destination.
Domain: Cooperating collection of interconnected Level 2 nodes that are able to exchange messages between them an on behalf the Level 1 nodes that reside within each of the above given areas.

The following documents are incorporated herein by reference in their entirety.
(1) ISO 10589—Intermediate System to Intermediate System intra-domain routing information exchange protocol.
(2) ISO 8473—Protocol for providing the connectionless-mode network service/
(3) ISO 9542—End System to Intermediate System routing exchange protocol.
RFC 1574—Essential Tools for the OSI Internet. (This is actually an overview with references to other documents, and a good place to start.)

Further aspects of the invention include the following:

A method of establishing communication with a network element comprising:
(1) logging into said network element;
(2) transmitting to said network element one or more prompts each of which causes said network element to return a response;
(3) receiving and analysing each response; and
(4) determining a method of connection to said network element based on said one or more response.

A method further comprising the step of determining the type of network element and/or network element vendor and/or manufacturer based on said one or more response.

A method comprising selecting a next prompt based on the response of said network element to a previous response.

A method further comprising the step of selecting a method of connection from a list of connection methods according to network element type.

A method wherein said connection method enables communication with said network element over the application layer

A method wherein said application layer is an OSI application layer.

A method further comprising using the determined communication method to retrieve information about other network elements with which said network element has communicated or is communicating.

A method of determining the topology of a network comprising establishing communication with one or more network elements;
determining from said one or more network elements, the identity of one or more other network elements on the network;
and determining one or more positional relationships between a plurality of said network elements.

A method as wherein the identity of other network elements is determined using OSI application layer communications.

A method wherein said relationships are determined using OSI network layer communications.

A method wherein the step of determining one or more positional relationship comprises the step of performing OSI trace route to determine information about network elements on a communication path of said network.

An apparatus for discovering information on a communications network, comprising
means for transmitting a signal to a network element to retrieve therefrom information about said network element,
means for identifying the network element from the retrieved information,
means for selecting a method of connecting with said network element based on the identification thereof, and
means for establishing a connection with said network element using the selecting method.

An apparatus further comprising storage means for storing the identity of a network element identified by said identifying means.

An apparatus further comprising means for generating and transmitting a request to a network element, requesting information about other network elements stored therein, and means for receiving and storing said information.

An apparatus wherein said generating means is arranged to generate and transmit requests for said information at spaced intervals of time.

An apparatus wherein said storage means is adapted to store information about any new network elements resulting from each successive request.

An including relationship extracting means for extracting a positional relationship between network elements based on the retrieved information.

An apparatus further comprising means for generating and introducing on said communications network a signal which causes a response from a network element after said signal has passed through a predetermined number of network elements and response receiving means for receiving said response.

An apparatus wherein said response contains information about the network element responding to said signal.

An apparatus wherein said information includes information identifying an aspect of said network element.

An apparatus wherein said signal generating means is arranged to generate a plurality of signals wherein different signals are arranged to cause a network element to respond thereto after said signal has passed through different numbers of network elements.

An apparatus further including storage means arranged to store information identifying different network elements which respond to said signals and the positional interrelationships between said network elements.

An apparatus further comprising output means for outputting the information containing said positional interrelationships.

A method of discovering network elements on a network comprising the steps of retrieving information from a network element about other network elements on the network and using the retrieved information to communicate with the discovered network elements to retrieve further information about said network elements.

A method wherein said further information comprises information which allows communication over the application layer.

A method of discovering network elements on a network comprising the steps of retrieving from a network element information about other network elements on the network, communicating with a network element so identified and requesting therefrom information about other network elements on the network.

A method wherein the step of communicating is performed through an application layer.

A method further comprising the step of determining the positional relationships between a plurality of said network elements.

A method comprising communicating over a network layer to determine said one or more positional relationships.

A computer readable storage medium comprising code which, when in use, causes a network probe to perform a method as claimed in a preceding method claim or as described herein.

The use of an OSI application layer and an OSI network layer to determine information about network elements on a network.

Further aspects of the invention include an apparatus adapted to perform any one or more of the methods disclosed herein.

Modifications of the embodiments described above will be apparent to those skilled in the art.

1. A method of discovering information about a network element on a communications network, comprising the steps of selecting a candidate communication enabler from a plurality of different candidate communication enablers, each different candidate enabler permitting communication with a network element that is adapted to recognize said enabler, transmitting said selected enabler to a network element to discover if said network element is adapted to recognize said candidate enabler, monitoring the response, if any, to said candidate enabler from said network element, determining from said response if said network element is adapted to recognize said candidate enabler, and if it is determined that said network element does not recognize said candidate enabler, transmitting one or more different candidate enabler to said network element, monitoring the response, if any, to each further candidate enabler from said network element and recording the candidate enabler for that network element that is determined from a response from said network element.

2. A method as claimed in claim 1, wherein a candidate communication enabler comprises at least one of a communications method and an access key.

3. A method as claimed in claim 2, wherein said communications method comprises a method of communications that enables said network element to transmit information stored therein.

4. A method as claimed in claim 2, wherein said communications method comprises at least one of a management protocol and an adaption method.

5. A method as claimed in claim 2, wherein said access key comprises user login credentials.

6. A method as claimed in claim 1, comprising successively determining the management protocol for communicating with said network element, the access key for communicating with said network element and the adaption method for communicating with said network element by successively selecting candidate communication enablers and monitoring the response, if any, to each enabler from said network element.

7. A method as claimed in claim 1, further comprising using the communication enabler determined to be recognized by said network element to obtain information from said network element.

8. A method as claimed in claim 7, wherein said information comprises one or more identifiers identifying other network elements with which said network element has communicated, one or more resources of said network element and an identifier identifying another network element to which said network element is connected.

9. An apparatus comprising mean for performing the method of claim 1.

10. A computer readable medium containing instructions which, when executed perform in the method of claim 1.

11. A method of discovering information about a network in which a plurality of network elements on the network are each configured to use a different communication method to permit access to information stored in said network element, the method comprising the steps of attempting to communicate with each network element using one or more different communication methods, monitoring the responses, if any, from said network elements, and determining the communication method used by each network element based on the responses.

12. A method as claimed in claim 11, wherein at least one of said network elements is an Open Systems Interconnect (OSI) network element.

13. A method as claimed in claim 11, wherein at least one of said network elements is capable of communicating using an Internet Protocol (IP) communications method.

14. A network probe for discovering information about a network comprising means for detecting packets on a network, means for deriving from said packet the identity of a network area, means for establishing communication with network elements of said area, including means for transmitting one or more packets onto the network containing the area address and the identifier of said probe, and means for receiving information stored in one or more network elements in said area from said one or more network elements in said area.

15. A network probe as claimed in claim 14, wherein said information comprises the network address of at least one network element in said area.

16. A network probe as claimed in claim 14, further comprising means for transmitting a request to a network element in said area requesting the target identifier of said network element.

17. A network probe as claimed in claim 14, further comprising means for recording a plurality of area addresses detected from packets on the network, means for establishing communication with network elements in another network area, including means for transmitting a packet containing the area address and the identifier of said network probe.

18. A method of connecting a network probe to a network, comprising the steps of detecting packets on said network, deriving from said packets a network area address and establishing communication with network elements in said area, including transmitting a packet onto said network comprising the detected area address and an identifier identifying said network probe

19. An apparatus comrising means for performing the method of claim 11.

20. A machine readable recording medium contianing code which when executed on a computer performs a method of claim 11.

21 A method for discovering information about a network comprising the steps of:
(1) forming at a source a packet addressed to a destination network element,
(2) conditioning set packet to cause an intermediate network element on a communications path between said source and said destination network element to transmit a response to said source on receiving said packet, receiving said response at said source and deriving information about said intermediate network element from said response.

22. A method as claimed in claim 21, wherein the step of conditioning said packet comprises limiting the number of network elements that said packet can reach.

23. A method as claimed in claim 21, wherein the step of conditioning comprises conditioning said packet to stop before reaching said destination network element.

24. A method as claimed in claim 21, wherein the information contained in said response includes the address of said intermediate network element.

25. A method as claimed in claim 21, further comprising forming one or more further packets, conditioning each packet to cause a different intermediate network element on said communication path between said source and said destination network element to transmit a response to said source on receipt of a respective further packet, receiving said response at said source and deriving information about a respective network element from each response.

26. A method as claimed in claim 25, wherein the step of conditioning each further packet comprises limiting the number of network elements that each further packet can reach on said communication path.

27. A method as claimed in claim 25, wherein the information contained in each response comprises the address of the intermediate network element which the respective packet caused to transmit a response.

28. A method as claimed in claim 21, wherein said packet comprises an echo request packet.

29. A method as claimed in claim 21, wherein said response comprises an error report.

30. An apparatus comprising means for performing the method of claim 21.

31. A computer readable medium containing instructions which when executed perform the method of claim 21.

32. A method for discovering information about a network, comprising the steps of:
forming a plurality of packets, each addressed to a different network element on a network, setting in each packet the number of network elements that the packet can visit,
conditioning each packet to cause the respective destination network element to transmit a response to said source on receiving said packet and to cause one or more intermediate network elements between said source and said destination network element to decrement said number on reaching each intermediate network element and conditioning each packet to cause its respective destination network element to return the resultant number to said source,
transmitting said packets to their respective destination network elements, receiving at said source the resultant number transmitted by each respective destination network element, and determining the number of network elements between said source and said destination network element based on the number set in each packet and the resultant number received from each destination network element.

33. A method as claimed in claim 32, further comprising selecting a destination network element, forming a packet addressed to said destination network element, conditioning said packet to cause an intermediate network element between said source and said destination network element to transmit a response to said source on receiving said packet, and deriving information about said network element from said response.

34. A method as claimed in claim 33, further comprising one or more further packets, each conditioned to cause a different intermediate network element on said communication path between said source and said selected destination network element to transmit a response on receiving a respective further packet, and deriving information about each different intermediate network element from said response.

35. A method as claimed in claim 33, wherein said response contains the address of said intermediate network element.

36. A method as claimed in claim 33, wherein the step of selecting comprises selecting the farthest destination network element from said source.

37. A method as claimed in claim 36, comprising forming a plurality of packets, each addressed to said selected destination network element, conditioning each packet to cause a different intermediate network element between said source and said selected destination network element to transmit a response to said source on receiving a respective packet, receiving each response at said source and deriving information about each intermediate network element from each response.

38. A method as claimed in claim 37, wherein the step of conditioning each further packet comprises limiting the number of intermediate network elements that each packet can reach to a different number.

39. A method as claimed in claim 37, comprising recording an identity of each network element discovered on said communication path between said source and said selected network element, selecting another network element as a destination network element other than a network element discovered on said communication path, forming a packet addressed to said destination network element, conditioning said packet to cause a network element on said communications path between said source and said selected destination network element to transmit a response to said source on receiving said packet, transmitting said packet towards said destination network element, receiving said response, and deriving information about said intermediate network element from said response.

40. A method of discovering information about a network, comprising the steps of determining the distance that each of a plurality of network elements is from a source, selecting the network element determined to be farthest from said source and discovering which of the other network elements lie on a communication path between said source and said farthest network element.

41. A method as claimed in claim 40, further comprising the step of selecting the farthest network element that does not lie on said communication path between said source and said destination network element and discovering which network elements lie on a communication path between said source and said network element.

42. An apparatus comprising means for or instructions on a computer readable medium for performing the method of claim 32.

43. An apparatus comprising means for or instructions on a computer readable medium for performing the method of claim 40.

44. A method of discovering information about a network, comprising the steps of:
providing information about network elements on each of a first and a second communication path, each communication path being connected to a network probe, directing a packet from said probe to a predetermined network element on said first path, the packet causing said predetermined network element to transmit a packet towards a network element on said second path, the packet transmitted by said predetermined network element causing a network element it reaches beyond said predetermined network element to transmit a response to said network probe containing information about said network element,
receiving the response at said network probe and deriving from said response the information about said network element.

45. A method as claimed in claim 44, further comprising the steps of conditioning said packet to be transmitted by said network probe to cause said predetermined network element on said first path to transmit a packet toward said network element on said second path that causes said network element beyond said predetermined network element on said first path to transmit a response to said network probe on receiving the packet transmitted by said predetermined network element such that the response contains said information about said network element.

46. A method as claimed in claim 44, wherein said information comprises the address of the discovered network element.

47. A method as claimed in claim 44, wherein said predetermined network element on said first path is the farthest network element on said first path from said network probe.

48. A method as claimed in claim 44, wherein said packet is conditioned to cause said predetermined network element on said first path to transmit a packet towards the network element on said second path which is farthest from said network probe.

49. A method as claimed in claim 44, further comprising conditioning the packet to be transmitted from said probe to cause the predetermined network element to limit the number of network elements beyond said predetermined network element that said packet can reach.

50. A method as claimed in claim 44, further comprising the step of forming a plurality of packets to be transmitted by said network probe to said predetermined network element on said first path and conditioning each packet to cause said predetermined network element to transmit a packet towards a predetermined network element on said second path and conditioning each packet to be transmitted by said network probe to cause said predetermined network element to limit the number of network elements beyond said predetermined network element that each packet transmitted by said predetermined network element can reach to a different number.

51. A method as claimed in claim 44, further comprising the step of forming a plurality of packets for transmission by said network probe towards said predetermined network element on said first path and conditioning each packet to cause said predetermined network element to transmit a respective packet towards a different network element on said second path.

52. A method as claimed in claim 44, further comprising preforming a plurality of network elements for transmission by said network probe, each packet addressed to a different predetermined network element on said first communication path and conditioning each packet to cause each predetermined network element on said first predetermined path to transmit a packet towards said second path and to cause a network element beyond each predetermined network element on said first path to transmit a response on receiving said packet to said network probe containing information about the network element which transmits a respective response.

53. An apparatus comprising means for performing the method of claim 44.

54. A method of discovering information about a network, comprising the steps of:
forming a packet addressed to a predetermined network element, forming in said packet response information to be used by said predetermined network element in transmitting a response on receiving said packet, said response information comprising as the source address of the response, the address of a network probe and as the destination for said response the address of another network element and a limiter that limits the number of network elements that said response can reach, and which causes the network element determined by said limit to transmit a response to said network probe containing information about said network element, transmitting said packet to said predetermined network element and receiving at said network probe the report transmitted by the network element determined by said limit, and deriving information about said network element from said report.

55. A method as claimed in claim 54, wherein said packet comprises an echo request packet, said response comprises an echo reply packet, and said report comprises an error report.

56. A method for discovering information about a network, comprising the steps of:
forming a packet for transmission by a network probe addressed to a destination network element and which also specifies the address of a predetermined network element between said network probe and said destination network element, setting in said packet a limit on the number of network elements the packet can reach beyond said predetermined network element and conditioning said packet to cause the last network element capable of being reached by said packet as determined by said limit to transmit a response to said network probe on receiving said packet.

57. A method as claimed in claim 56, wherein said packet comprises an echo request packet and said response comprises an error report

58. An apparatus comprising means for performing the method of claim 54.

59. A computer readable medium containing instructions which when executed perform the method of claim 54.

60. An apparatus comprising means for performing the method of claim 56.

61. A computer readable containing instructions which when executed perform the method of claim 56.
